(19) United States
(12) Patent Application Publication
(10) Pub. No.: US 2026/0330656 A1
(43) Pub. Date: Oct. 22, 2026

(54) AUTOMATIC STRUCTURE TRACKING SYSTEM

(71) Applicant: CANON VIRGINIA, INC., Newport News, VA (US)

(72) Inventors: Fateme Fotouhi, Rancho Santa Margarita, CA (US); Xiwu Cao, Irvine, CA (US); Ralph McCann, Williamsburg, VA (US)

(21) Appl. No.: 19/652,451

(22) Filed: Apr. 20, 2026

Related U.S. Application Data
(60) Provisional application No. 63/792,096, filed on Apr. 21, 2025.

(51) Int. Cl. G06T 7/262; G06F 40/177; G06K 7/14; G06T 7/246; G06T 7/73; G06T 7/90

(52) U.S. Cl. CPC G06T 7/262; G06F 40/177; G06K 7/1417; G06T 7/248; G06T 7/74; G06T 7/90; G06T 2207/10024; G06T 2207/20081; G06T 2207/30204

(57) ABSTRACT

According to the present disclosure, a method for automatically tracking a structure within an environment includes generating a map of a plurality of moveable support structures within a real-space environment, obtaining a first image of each of the support structures at a first time, obtaining a second image of each of the support structures at a second time, determining offset information indicating a change in position of respective ones of the plurality of support structures between the obtained first and second images using a transformation parameter, and updating the generated map using the determined offset information to update position information for any of the moveable support structures determined to have moved during a time between the first image and the second image.

### CROSS-REFERENCE TO RELATED APPLICATIONS

This application claims the benefit of priority from US Provisional Patent Application Serial No. 63/792,096 filed on Apr. 21, 2025, the entirety of which is incorporated herein by reference.

### BACKGROUND

### Field of the Disclosure

The present disclosure relates to automatically tracking a structure in an environment.

### Description of the Related Art

Imaging devices such as pan, tilt, zoom (PTZ) cameras, are useful in generating images of a plurality of objects present in large areas. This imaging is achieved by controlling the various commands for each of the pan, tilt and zoom operation of the imaging device thereby providing a flexible solution for obtaining images in a large field of view. One environment where large scale imaging is desirable is in controlled indoor agriculture spaces that include large areas of densely packed vegetation. This is seen to solve an issue related to the current manner of monitoring vegetation being grown because of the reliance on human workers. Imaging in this environment resolves the inefficiency and human error associated with physical human inspection of vegetation in a large scale growing environment. Monitoring these spaces with imaging hardware reduces the manpower load and also allows for computer analysis which can be more rigorous, frequent and consistent in monitoring the space.

In these environments, even when using imaging to monitor these environments, there is still a need for human intervention when image analysis indicates that there is an issue with the health of the vegetation. As such, the support structures that hold trays in which the vegetation grow need to be moveable to allow for humans to travel through the environment to get to plants that are indicated as being unhealthy or when the result of image analysis indicates there is an anomaly. This is presents a problem because there needs to be accurate information as to the location of each plant within the environment relative to the image capture device. However, movement of the support structures introduces challenges with maintaining association of the images that are captured with their location. Previously, determining plant locations relative to image capture devices relied on a manual and static process. Technicians manually repositioned the gantries to a predefined reference point (packed in the center of the room), aligning them with previously recorded measurements to estimate their locations. This approach was labor-intensive, time-consuming, and prone to human error. Additionally, it provided only a snapshot of gantry positions rather than capturing their continuous movement. Another method involved visually estimating gantry positions using a fixed floor grid, but this proved inaccurate. The lack of automated tracking hindered efficient plant monitoring and data analysis, making it difficult to link images to specific plants on moving gantries.

### SUMMARY

According to the present disclosure, a method for automatically tracking a structure within an environment includes generating a map of a plurality of moveable support structures within a real-space environment, obtaining a first image of each of the support structures at a first time, obtaining a second image of each of the support structures at a second time, determining offset information indicating a change in position of respective ones of the plurality of support structures between the obtained first and second images using a transformation parameter, and updating the generated map using the determined offset information to update position information for any of the moveable support structures determined to have moved during a time between the first image and the second image.

In another embodiment, the method further includes detecting, in the obtained first image, a position of a unique indicator associated with a respective one of the respective moveable support structures, detecting, in the obtained second image, the position of the unique indicator associated with the respective one of the respective moveable support structures; and wherein the activity of determining the offset information uses a change in pixel location of the unique indicator between the first obtained image and the second obtained image.

In another embodiment, the method further includes obtaining further images of the environment each having position information indicating a position of the environment where the image was obtained, comparing the position information in the obtained further images with the updated map; and assigning the obtained further images to a corresponding structure based on the updated map.

In a further embodiment, the method also includes determining the transformation parameter by obtaining a pixel-to-feet ratio using a size, in pixels, of an indicator within the obtained first and second images, movement direction and a know size of the indicator in real space.

According to the present disclosure, the transformation parameter indicates a displacement distance in real space and direction information, and updating the generated map includes using a displacement distance and direction information to update a position of respective ones of the support structures.

In another embodiment, the method further includes providing a plurality of image capture devices positioned at predetermined positions within the environment; and the step of obtaining the first image and second images is performed by the plurality of image capture devices.

In another embodiment, the method further includes extracting from each of the obtained first and second images, a set of pixels having a predetermined image characteristic, and using a change in position of the predetermined image characteristic to determine the offset information. In one instance, the predetermined image characteristic is a grouping of pixels having a same color information. In other instances, the predetermined image characteristic is a presence of a fluorescent marker and/or presence of white light information. Alternatively, the predetermined image characteristic represents a two-dimensional code.

In another embodiment, the method further includes providing the obtained first image and obtained second image as input to a trained machine learning model trained to identify one or more indicators on respective support structures, using output from the trained machine learning model in determining the offset information.

In another embodiment, the step of obtaining the first image and obtaining the second image further includes obtaining an image of the support structures and a predetermined point in the imaging region, and wherein the step of determining offset information uses a position in the obtained first and second image relative to the predetermined point in the imaging region.

In another embodiment, wherein after the step of updating the generated map occurs at a first time, the method further obtains subsequent images at a time after the second time and compares a location of the support structure in the subsequent images with the generated map.

According the present disclosure, a server is provided and includes one or more memories storing instruction and one or more processors that, upon execution of the stored instructions, are configured to execute a method according to any or all of the embodiments described in the present disclosure.

According to the present disclosure, a system is provided and includes a plurality of image capture devices configured to obtain images of an environment and an information processing apparatus including one or more memories storing instructions; and one or more processors that, upon execution of the stored instructions, are configured to execute a method according to any or all of the embodiments described in the present disclosure.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 illustrates an exemplary image capture environment according to the present disclosure.

FIG. 2 illustrates a zoomed out view of the environment shown in FIG. 1.

FIG. 3 depicts exemplary images captured that illustrate the problem associated with structure movements in the exemplary image capture environment.

FIG. 4 depicts a tracking mechanism used in accordance with the algorithm of the present disclosure.

FIG. 5 is an exemplary algorithm for tracking structures in an image capture environment according to the present disclosure.

FIG. 6 illustrates an algorithm to generate a rotation matrix along with cropped images generated using the matrix according to the present disclosure.

FIG. 7 is an exemplary algorithm for tracking structures in an image capture environment according to the present disclosure.

FIG. 8 is an exemplary algorithm for tracking structures in an image capture environment according to the present disclosure.

FIG. 9 illustrates a system according to the present disclosure.

FIG. 10 is a block diagram of hardware that executes one or more algorithms according to the present disclosure.

The accompanying drawings, which are incorporated herein and form part of the specification, illustrate various embodiments, objects, features, and advantages of the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION OF EXEMPLARY EMBODIMENT

The present disclosure has several embodiments and relies on patents, patent applications and other references for details known to those of the art. Therefore, when a patent, patent application, or other reference is cited or repeated herein, it should be understood that it is incorporated by reference in its entirety for all purposes as well as for the proposition that is recited.

It is noted that the embodiments described herein can be used in combination with any of the embodiments provided in U.S. Patent Application Serial. No. 17/272,079, filed Feb. 26, 2021 as the national phase entry of Patent Cooperation Treaty Application No. PCT/US19/48602 filed Aug. 28, 2019 and claiming priority to U.S. Provisional Patent Application Numbers 62/818,432 filed Mar. 14, 2019 and 62/725,137 filed Aug. 30, 2018, each of which is hereby incorporated herein in their entirety.

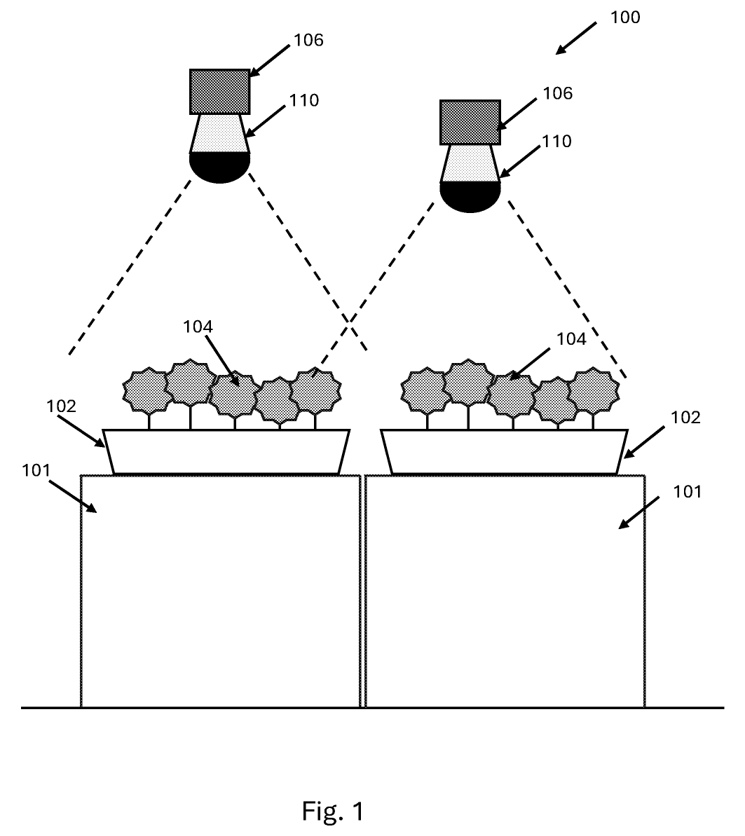

In exemplary operation, as shown in FIG. 1, the present disclosure will reference the camera control operations and image capture operations with regard to an indoor agriculture environment where vegetation is being grown under controlled environmental conditions. Because of the nature of these environments, the positions and/or orientations of the image capturing devices (e.g. PTZ cameras) may not be consistent, and plants are located at varying distances away from the cameras, and thus capturing images of the vegetation being grown by different cameras generates images having different resolutions and sizes. In a case where the captured images are being used and processed by an image processing application executing on a computing device (e.g. server or edge computing device) to determine whether any of the vegetation in those images are suffering from health defects, having input images with different sizes and resolution makes the determination more difficult. In certain instances, the input images are input to an information processing device (e.g. server) that has trained machine learning model that has been trained using images of the same vegetation being captured by the image capture device to classify vegetation in those images as being healthy or defective such that the vegetation is suffering from one or more plant diseases or pest infestation. As such, the presently disclosed image capture control algorithm advantageously controls one or more movements of the one or more image capture device (e.g. PTZ camera) operating in the environment to continuously scan an image capture region and capture a plurality of images of that region at a constant resolution.

In FIG. 1, an exemplary image capture environment 100 is illustrated. The exemplary environment 100 is a controlled indoor agricultural growing environment where one or more types of vegetation are being grown. In certain instances, FIG. 1 represents an indoor farming facility whereby all environmental factors are controlled and tailored to one or more specific types of vegetation that are being grown therein. As shown in FIG. 1, a plurality of vegetation support structures 101 are provided. These support structures 101 support one or more grow trays 102 in which one or more types of vegetation 104 are being grown. In certain embodiments, the support structure 101 need not be a grow tray 102 but can be any container that is able to hold/retain the vegetation being grown in the grow environment. For example the container may retain/hold a growth media and roots of the vegetation. In one embodiment, the growth media is soil or hydroponics or any other media able to provide nutrients to a root structure and which results in growth of vegetation. In one embodiment, the support structures 101 may be tables that are moveable about a floor of the facility. In another embodiment, the support structures 101 are gantries whereby there could be single or multi-level support structures that support the growth of one or more levels of vegetation. Also provided in grow environment are a plurality of overhead support structures 106. In one embodiment, the overhead support structures may be a roof of the facility. In another embodiment, the overhead support structure 106 is a support beam and the facility includes a plurality of support beams. In other embodiments, the overhead support may be a member of a gantry that is supporting a respective grow tray 102 and is positioned above the grow tray 102. In another embodiment, the overhead support structure 106 are poles extending upward from a floor of the facility. In this embodiment, the support poles have an end disposed at a predetermined height above the floor from which the pole extends. One or more image capture devices 110 are connected to respective overhead support structures 106. In one embodiment, the image capture devices 110 controllable to perform at least three movement operations to modify the field of view being captured at a given time. For example, the image capture devices 110 may be pan tilt zoom (PTZ) cameras which are controllable to capture one or more image capture regions of vegetation 104 growing in respective grow trays.

The facilities where the grow environments 100 exist also include a plurality of environmental control mechanisms that help control the environmental factors to ensure that the vegetation 104 growing in soil of the grow trays 102 are optimized to ensure successful growth. Environmental control mechanisms include, but are not limited to, lighting elements, heating elements, humidifiers and/or dehumidifiers, ventilation elements such as ductwork and/or fans. All of these environmental control mechanisms are deployed and supported on the same or other support structures within the facility to ensure the vegetation 104 is growing to yield as much crop as possible within a given growth cycle.

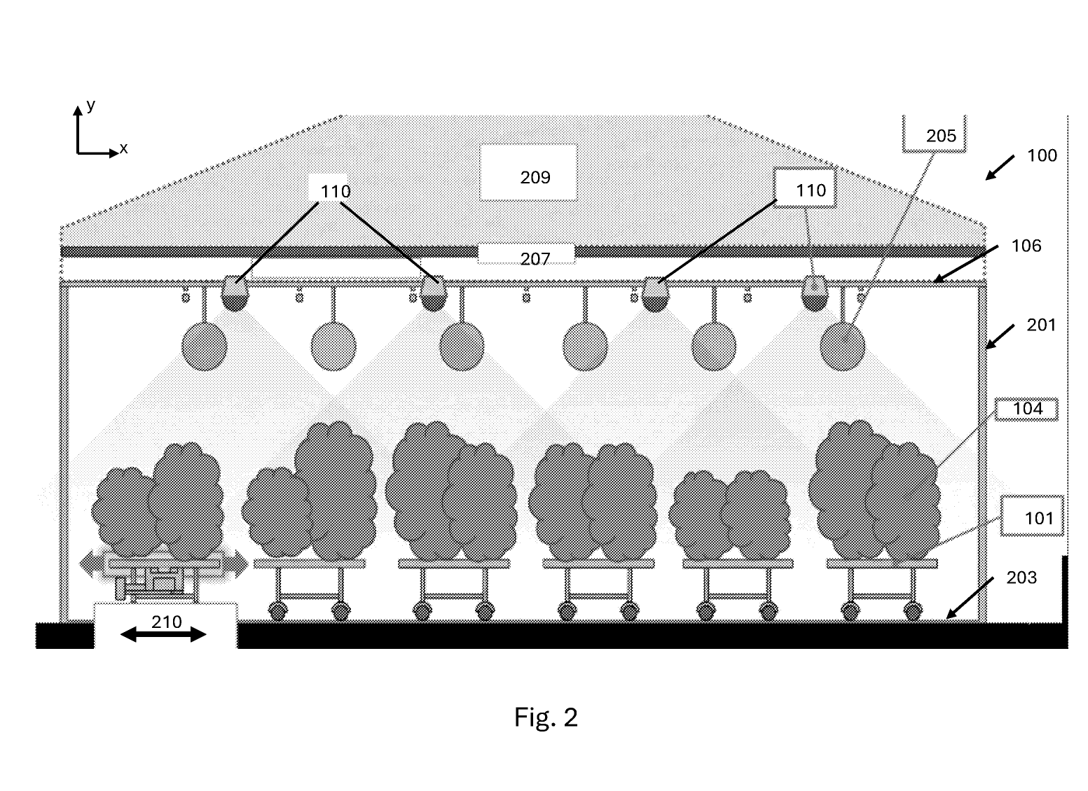

FIG. 2 illustrates a zoomed out view of the environment 100 shown in FIG. 1. The zoomed out view illustrates an exemplary structure 201 whereby a plurality of support structures 101 that are each moveable in the x and y direction is shown. As shown in FIG. 2, the environment 100 is an indoor greenhouse 201 where fixed image capture devices 110 (e.g. cameras) are positioned at predetermined locations within the greenhouse. Each of the plurality of image capture devices 110 are selectively connectable to the overhead support structure 106 and are positioned above mobile support structures 101 (e.g. gantries or tables) that hold the plants 104 as they grow. In exemplary operation, support structures 101 (e.g. gantries or tables) have the ability to move within a predetermined limited range and defined direction illustrated by the arrow labeled 210. In one embodiment, the range and direction may be two feet horizontally. However, this depends on the structural constraints associated with the environment including size and number of support structures at a given time. As such, the movement range 210 may be more or less than two feet and the direction of movement may be vertical, or both vertical and horizontal. In one embodiment, the vertical movement is in real 3D space. For example, the gantry 101 moves in a single direction with a long axis shifting parallel such that it shifts along the short axis. As such, the trays are moveable in the real 3D space vertical access by raising and/or lowering by disassembling and reassembling. In another embodiment, the movement (either vertical and/or horizontal) correlates with the captured image as it is being displayed on a display screen.

In the exemplary environment 100 shown in FIG. 2, the housing 201 is shown including a floor 203 on which a plurality of moveable support structures 101 are disposed. The housing includes the overhead support 106 such as a truss that has the plurality of image capture devices 110 (e.g. PTZ cameras) positioned at a predetermined distance above respective support structures 101. A plurality of fans and lighting 205 and other environment control mechanisms are also connected to the overhead support truss 106. The housing 201 further includes a shade shutter 207 positioned above the overhead support structure 106 and image capture devices 110. Positioned above the shade shutter may be a space 209 that can may or may not be accessible.

As noted above, it is desirable to employ the image capture system shown in FIG. 2 that includes a plurality of image capture devices 110 positioned at predetermined locations and which are controlled, via an image capture algorithm, to capture images of the plants 104 being grown. These captured images are then provided as input to one or more detection models (e.g. trained machine learning model such as a neural network, CNN, or the like), which then detect and classifies individual plants leaves in each of the captured images as being healthy or having a defect or other anomaly (or category of interest) associated therewith. As such, the health of the plants can be continually monitored automatically while minimizing human labor associated with doing so. Since these support structures are moveable, and there is a need to know the precise location of plants within the grow tray and also know the precise location of the grow tray that is being supported by the moveable support structure, accurately tracking their positions within the greenhouse environment and relative to the cameras is essential. Precise localization is critical to ensuring that captured images are correctly associated with the corresponding plants, thereby enabling customers to identify which gantry 101 a specific plant 104 belongs to.

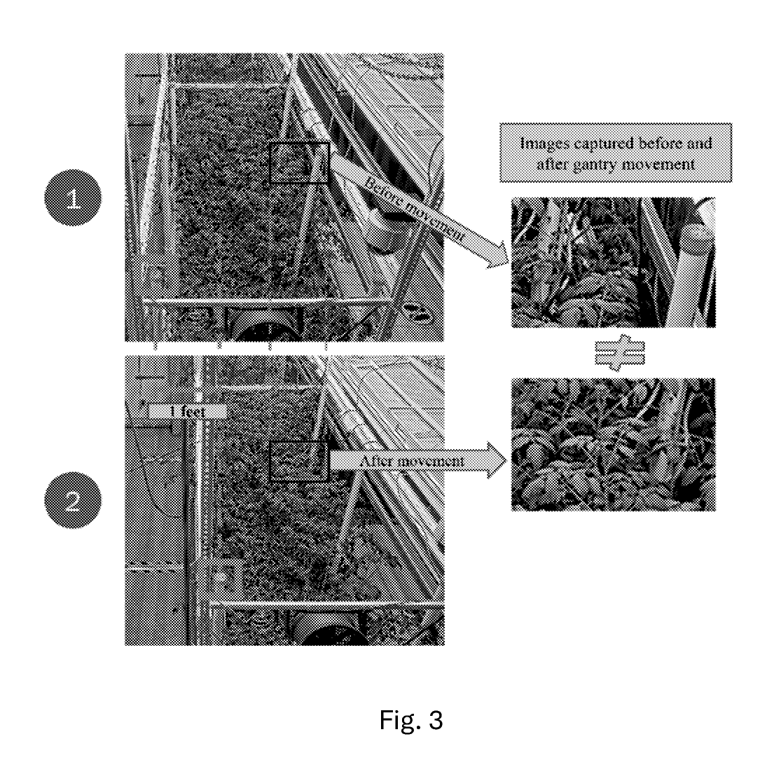

However, the movement of the gantries 101 introduces challenges in maintaining the association of plants in respective images being captured with the tray and support structure on which they are located. This issue is illustrated in FIG. 3 while illustrates exemplary images captured before and after a gantry's displacement. Due to this movement, the same camera no longer captures the same plants, leading to discrepancies in image-to-plant mapping. This is illustrated via the sold line box in the image labeled “1” and in the image labeled “2”. In each of Image 1 and Image 2, the solid line box is positioned at the same pixel location within the captured image. However, when looking to the zoomed in content in the images on the right, it is clear that the same region in the captured image contains different content when captured at a first time (before movement) and a second time (after movement).

When scaled to a greenhouse environment with multiple adjacent gantries, the complexity of tracking increases significantly. As multiple gantries move, determining the origin of each captured image becomes increasingly challenging. The present disclosure provides a tracking algorithm that, when executed, provides a robust tracking system that reliably maps images to the correct support structures. According to the present disclosure, the tracking algorithm provides a solution to the problems associated with tracking multiple moveable support structures within a particular environment and does so by continuously monitor support structure (gantry or table) positions and updating their locations which ensures accurate image-to-plant correspondence. This further improves the reliability of subsequent image analysis performed on each of the captured images to correctly identify locations of plants/vegetation that have been analyzed and for which anomaly or other plant defect (or other category of interest) has been detected.

The core challenge addressed by this method is the need for an automated system to track the movement of plant-holding gantries within a greenhouse environment that improves upon the manual repositioning and location operation that had previously been employed. The tracking algorithm according to the present disclosure enables continual monitoring of support structure position using a sequence of captured images from one or more image capture devices. This is a direct improvement to the manual positioning of these support structures at defined locations at particular intervals. The present disclosure improves existing mapping algorithms which required manual positioning the support at a location (e.g. the center of the room), aligning the positioned support structures with a predefined reference file that contains their actual locations which is then used to determine the positions of the support structures and associate captured images with the correct support structure based on its recorded location (which is assumed to be the center if positioned accordingly).

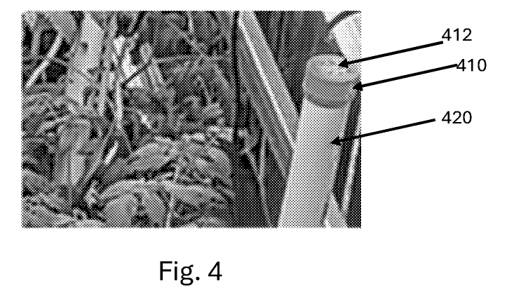

The present disclosure provides an improved tracking algorithm that uses a marker-based tracking system. This is illustrated in FIG. 4, which is an image from FIG. 3. According to the present disclosure, plants are supported on the moveable support structure, which as shown herein, is a gantry. In FIG. 4, a support structure-specific indicator 410 is provided and is supported by an indicator support member 420. Each support structure-specific indicator has a known size in real space such that a transform parameter is usable to transform a size of the indicator in a captured image to a size in real space and which enables a determination of how much distance a support structure has moved and also a direction of that movement.

In one embodiment, the indicator 410 has a unique physical characteristic that allows for easy detection during image analysis, as will be discussed below. For example, the physical characteristic may be a unique color such that image analysis can be performed to identify regions in a captured image having the unique color. In another embodiment, the unique indicator may be a predetermined shape (e.g. circular). According to the present disclosure, each of the support structures has unique indicators 410 that use one or more reference markers 412. In one exemplary embodiment, the reference marker is a two dimensional code such as a barcode or a QR code. In another embodiment, the indicator is the support structure itself. Accordingly, the tracking algorithm leverages principles of computer vision to offer a more direct method for determining object positions within images captured by overhead cameras as opposed to requiring manual human intervention to reposition them. By automating gantry tracking, this method eliminates manual resets, provides continuous position monitoring, and enhances accuracy. In other embodiments, the position monitoring may be performed in an “on-demand” manner. Furthermore, the tracking algorithm consistently checks and provides constant monitoring of gantry positions over time also improving accuracy in the identification of plants/vegetation that need to be attended to, such as when it is determined that one or more plants are not healthy by linking images to specific plants and gantries and improving plant analysis.

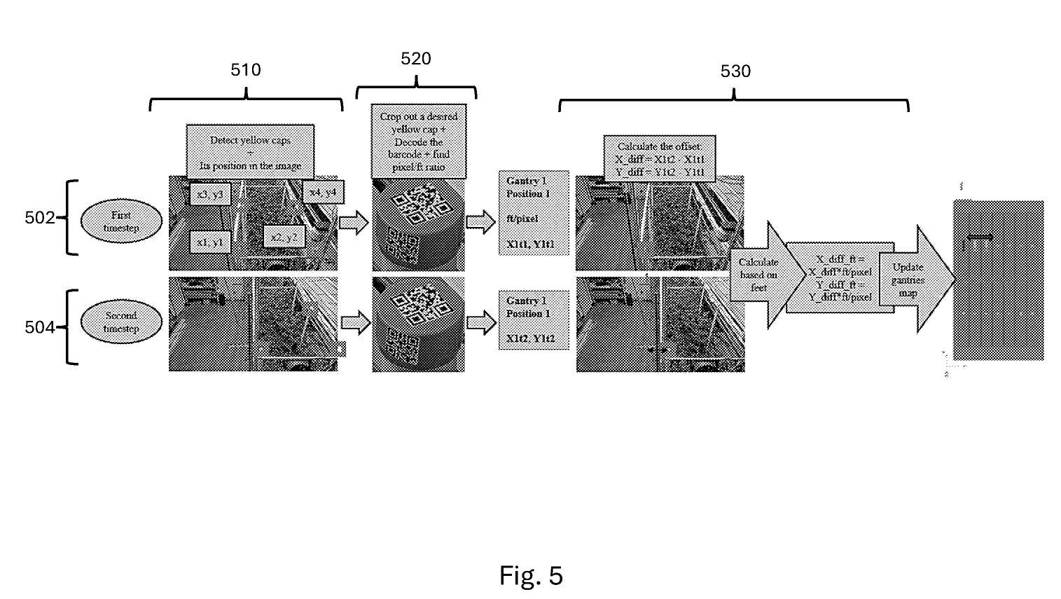

In exemplary operation, tracking algorithm will obtain a series of images from the plurality of image capture devices associated with the environment. From the obtained images, detection processing is performed whereby indicators (and any associated marker positioned therein) on the gantries are detected and position information representing a position in the image based on image coordinates (pixel values) are recorded. In one embodiment, the detection processing generates a map of support structures in a given environment and associates a respective support structure with position information indicating a position in real-space. Once the indicators are identified, offset determination processing is performed which calculates an offset value associated with gantry movement by comparing images taken from the same camera at different time points. This step advantageously automates gantry tracking thereby eliminating the need for manual repositioning. Update processing is performed that updates position information of support structures between successive images. In one embodiment, a support structure position map stored in memory is caused to be updated using the calculated offsets. In do so, a reference file containing the gantries' locations based on the calculated offsets is updated. Thus, in each newly captured image, which includes room coordinate information as part of its metadata, is continually checked against the updated support structure map including the locations various support structures to ensure that plants detected in the subsequently captured images are assigned to the corresponding support structure. These steps will be explained in detail in the following sections. The following descriptions will be made with reference to FIGS. 5 – 8.

### Detecting unique indicators/markers

Turning to FIG. 5, two different processing flows associated with a first time step 502 and a second time step 504 are illustrated. The operations performed at respective time steps at certain aspects of the described stages include analogous processing. In exemplary operation, a first detection stage 510 is performed as shown in FIG. 5. In the first detection stage 510 any identifiable and unique component positioned on the support structure can be used as an indicator. In certain embodiments, the indicator may have a sub-indicator element or marker (e.g. two dimensional code). In one exemplary embodiment, an indicator having a predetermined color that differs significantly from a color of objects of interest in the captured image is used to maximize robustness, scalability, and testing reliability. For example, in a case where the target object is plant leaves which are green an indicator having a color such as yellow is used. While the use of the color yellow is described herein, that should not be seen as limiting. Any other color that is different from a color of the objects being imaged and which is readily detectable via image processing methods may be used. Moreover, the indicator is supported by an indicator support member such as PVC pipes, that positioned around the gantries. In other embodiments, the indicator supports may be any support structure that is attached to the moveable object. Additionally, to further enhance robustness, a marker having a two dimensional code is also included as part of the indicator. In one embodiment, the marker is a QR codes that is positioned on a top side of the indicator which provides support structure-specific information (e.g. gantry specific information). This advantageously enables the algorithm to identify not only the support structure on which the indicator is mounted but also a particular region of the support structure is detected. For example, the indicator and marker may have information encoded thereon which indicates that a particular indicator belongs to a first position of a first support structure (e.g., a QR code may contain information such as "Gantry/Table A – Position 1").

In performing the detection processing, the algorithm obtains the images and analyzes them to detect and identify pixels in the image having color values that match a color of the indicator by using a computer vision technique that thresholds yellow pixels in the image. By constraining the detection to specific areas, regions having the predetermined color value closest to the indicator are searched and analyzed. In some embodiments, where the indicator has a marker such as a QR codes, decoding the information stored in the QR code is performed to further ensure that a region of the image where detection processing finds an indicator is verified in a verification step to ensure accurate detection of the indicator that is identified.

Once an indicator having the predetermined color and shape (e.g., a yellow cap or label) is detected, the detection processing analyzes a contour of the indicator to estimate its diameter based on pixel values. In one embodiment, this aspect of the detection processing is performed extracting regions of a captured that are suspected to contain the indicator and providing the extracted candidate images to a trained machine learning model (or other deep learning method) that is trained to recognize that an indicator is present in the extracted region of the image and also to estimate a size of the candidate region in pixel values.

Upon determining that an image includes the indicator, position information of the indicator is extracted and recorded in memory in memory during an extraction stage 520. This includes identifying pixel coordinates for the indicator and recording these pixel coordinates in memory. This is performed on each image captured (e.g. at time step one 502 and time step 504) by the image capture devices 110 beginning an initial time and continuing for each image captured at subsequent times. This allows the system to compare detected indicator positions across subsequent time steps and determine any offsets between indicator positions detected between at least two images. In a case where offsets in pixel locations of the indicator is present, it is presumed that the offset is caused by movement of the support structure. This processing is illustrated in FIG. 5, where the indicators representing detected yellow caps and their corresponding locations in the image are labeled as x1,y1, etc. To ensure that a detected indicator (e.g. yellow cap) in one image corresponds to the same cap in an image captured a next (subsequent) time step, the use of unique QR codes is provided. To accurately read the QR code and decode its information, crop processing is performed by expanding a boundary a predetermined number of pixels on each side of the detected indicator (e.g. the yellow cap region). The cropped images will be preprocessed to enhance the visibility of the QR codes, involving converting the image to grayscale and applying Contrast Limited Adaptive Histogram Equalization (CLAHE) to improve contrast. This allows for the tracking algorithm to decode the information using QR code reading algorithms such as qreader or Zxing.

In another embodiment, in a case where the indicator does not contain a marker (e.g. no QR code) and the indicator themselves are the only distinguishable item in the image which represents the support structure-specific information, an alternative identification method can be used such as using the indictor only when it is determined to be at a predetermined location within the captured image. (e.g., considering the indicator position being on the right side of the image as a valid indicator). In this case, even if an image contains multiple support-structure specific indicators, using only indicators at the predetermined position can faithfully identify which support structure particular plants are associated with. In another embodiment, the support structures themselves may have unique visually detectable characteristic that can be identified in a captured image to ensure plants are associated with the correct support structure.

Upon detecting a presence of an indicator in a captured image, a tracking and translation stage 530 is executed and includes translation processing that is performed to translate a size of the indicator in the captured image into a size in real-space. This processing includes determining a key parameter representing a pixel-to-feet ratio which is determined using the detected diameter of the indicator (e.g. diameter of a yellow cap in pixels) and its known real-world diameter in feet. This ratio is essential for subsequent steps and is also illustrated in FIG. 5. The selected diameter of the indicator in the image is the one along the direction of motion. This helps provide a more accurate relationship between the value in image coordinates and the real-world measurement, which may be affected by the perspective from which the image is captured. For example, the image may not always be taken from a top-down view of the indicator so this arrangement improves the accuracy. As a result, the indicator may appear to have different diameters in different directions, but the control algorithm makes use of the diameter along the direction of movement.

In some cases, this key parameter is not a single scalar value but a function that allows mapping the pixels to feet based on the direction of translation of the makers in two images. In reality, a circular cap can appear as an ellipse in the image depending on the pan and tilt angles, showing different pixel values for its dimensions in different orientations. This information needs to be included to calibrate the pixel-to-feet ratio, providing a more accurate estimation of the pixel-to-feet ratio that takes into account the movement direction of the structures.

### Tracking Support Structure Movement

Upon detecting indicators and recording positions in the image of the detected indicators, the transformation parameter value which transforms the pixel size to a real-world size is stored in associated with each detected indicator. As such, the positions in the image along with the pixel-to-feet ratio is recorded and stored in memory. This is performed as part of a tracking stage 540.

To track the movement of the support structures, the tracking and translation stage 530 includes performing a comparison between two successively captured images which are images taken at two different time steps (502 and 504). The processing illustrated in the translation and tracking stage 530 includes images captured at the first time step 520 having detection processing and extraction processing performed thereon as well as on images captured at a subsequent time step 504. Upon obtaining images a first time 502 and subsequently at a second time 504, the position of each detected yellow cap is extracted from both images. By comparing these positions, a determination is made whether a cap has moved between the two-time steps. If movement is detected, an offset displacement calculation is performed to calculate the offset displacement the indicator in pixel units between the two images. Using the previously determined translation parameter which includes a pixel-to-feet ratio, conversion processing is performed to convert this determined displacement into real-world units (feet), providing an accurate measure of the gantry's movement. This process is repeated for all gantries in order to update the gantry map within the room.

As shown in FIG. 5, after detecting the indicator, decoding the QR codes on the indicator, and extracting indicator locations from the image, information from two images taken at different time steps is compared. By analyzing the differences in positions, the offset between the indicator in respective images is calculated in pixels and translated into distance information representing a real-world value representing a distance that the support structure has moved over time enabling accurate tracking of gantry movement over time.

In another embodiment, by monitoring multiple indicators on the same support structure, rotation and/or misalignment information can be inferred if different indicators exhibit varying displacement patterns between successively captured images. This advantageously improves the accuracy of the support structure movement estimation by tracking multiple indicators using this method and applying any aggregation methods to estimate the optimal value for displacement. For example, a weighted averaging can be performed here, which means assigning greater weight to indicators that are closer to the camera because indicators nearer to the image capture device appear larger in the captured image and pixel measurements may be more precise leading to a more reliable estimation of movement.

### Adaptive image cropping for robust motion tracking

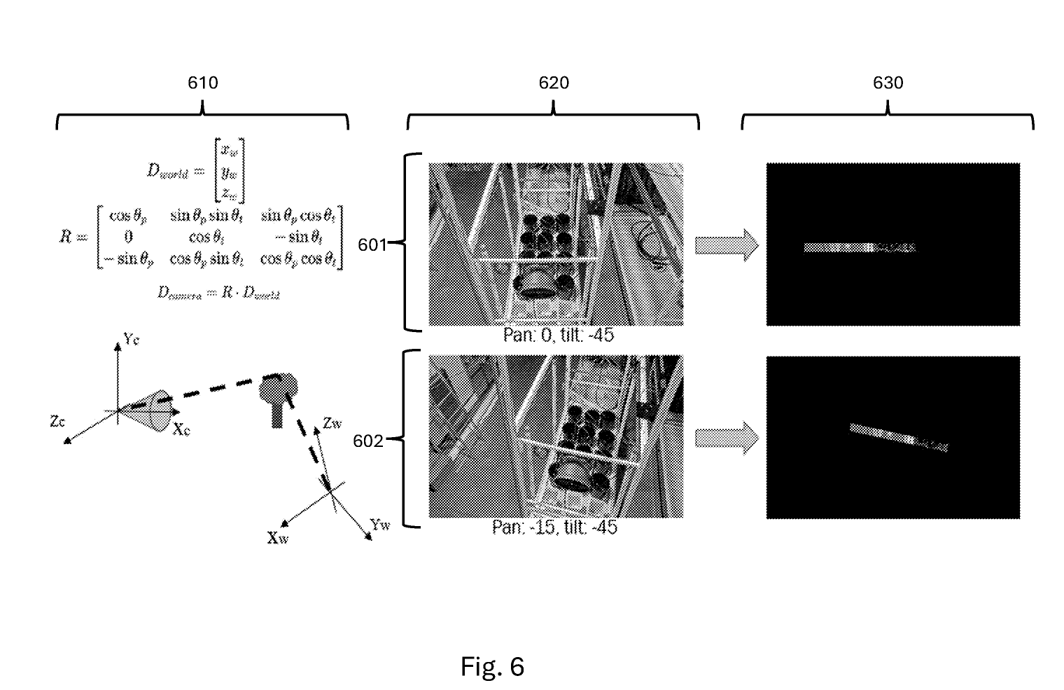

FIG. 6 illustrates examples 601 and 602 of cropped images after computing the direction of movement based on pan and tilt values. By limiting a region in a captured image to one or more candidate images, indicator detection processing is improved, yielding an improved support structure tracking process. Limiting detection to the specific region of the image where the indicator (e.g., yellow cap) is expected to appear, even after movement, allows for this improvement to be realized because the indicator detection processing is focused, thereby reducing unnecessary computations and improving accuracy. To achieve this, a determination is made as to the indicator's direction or the support structure direction of movement within the image.

To determine the support structure motion direction, it is expected that movement occurs in the world coordinate system. The support structures (gantries) are designed to move along the Y-axis in world coordinates, represented as [0,1,0]. However, because the image capture device capturing these images may have different orientations due to variations in pan and tilt values, the motion direction from the camera’s perspective may not align perfectly with the world coordinate system. To accurately interpret the support structure movement, the tracking algorithm considers the camera’s orientation and how it transforms world coordinates into image coordinates.

An extrinsic matrix is used to perform this determination. The utilized extrinsic matrix is derived from one or more operational values of the image capture device. In one embodiment, the one or more operational values includes a current pan value and a current tilt value. This matrix transforms world coordinates into the image capture device’s viewpoint allowing an accurate determination of the direction of the support structure’s movement relative to the image frame. The mathematical calculation of the rotation matrix 610 is shown in FIG. 6. Using this information, crop processing stage 630 is performed to crop the image 620, ensuring that the region of interest remains within the image frame being captured. The cropping processing is guided by a reference size of the indicator, which serves as a key feature for tracking movement.

During crop processing stage 630 of the image 620, it is essential to include a margin to ensure the indicator remains visible in each frame. If the crop is too tight, the reference point may be lost making consistent motion tracking difficult. The margin helps account for slight variations in movement and potential inaccuracies in motion estimation. By carefully adjusting the cropping parameters based on the position, size, and determined motion direction of the indicator, tracking continuity is maintained while optimizing the field of view for further analysis.

In another embodiment, in addition to the motion estimation described above using pan, tilt, and the extrinsic matrix, a second motion estimation process can also be performed. The second motion estimation processing relies on the locations of the indicators in two images, captured from the support structure with a defined pan, tilt, and zoom setting at different time steps. Comparing these values can also serve as an additional validation step to assess the accuracy of the camera’s mounting or identify potential installation errors.

### Gantry Location Mapping Workflow

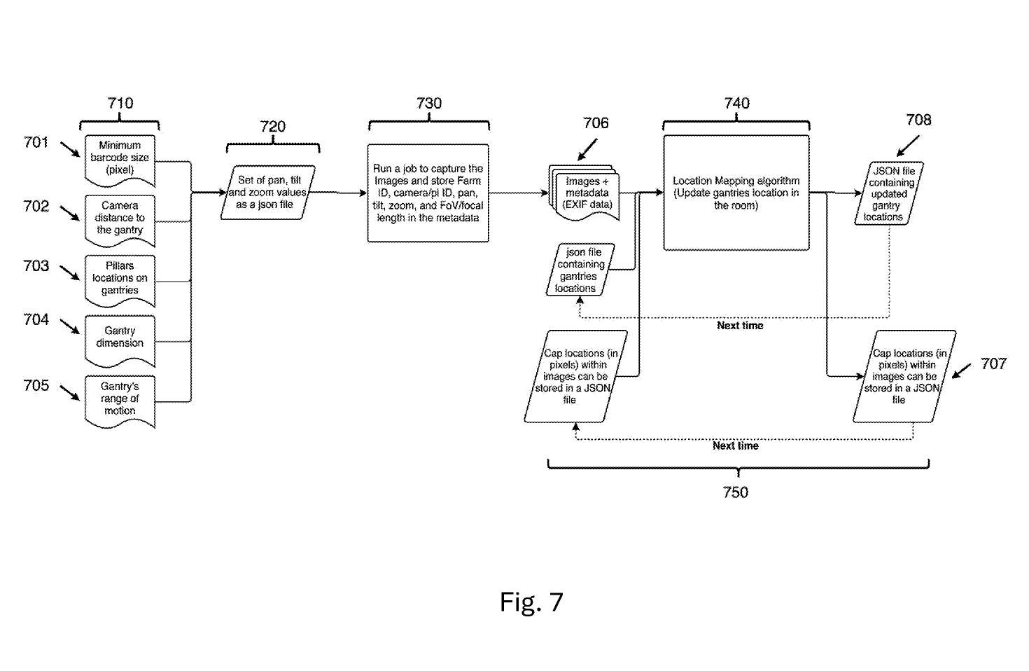

Once detection and offset processing are performed, the tracking algorithm initiates movement tracking processing to accurately track the movement of support structures in a room. This processing includes performing a set of instructions that are executed by one or more processors, which represents a structured process that involves capturing images, extracting key information, and updating the support structure locations over time. FIG. 7 is a flow diagraming detailing the processing steps performed when the tracking algorithm is executed by one or more processors of an information processing device or server.

At a first stage 710, parameter definition is performed whereby a set of predetermined parameters that influence image capture are set. For example, as minimum barcode size in pixels 701 along with a distance of the image capture device from the respective support structure that it is set to capture 702, an location of indicator support members connected to respective ones of the plurality of support structures 703, real-world dimensions of the respective support structures 704, and a motion parameter that identifies a range of motion of the respective support structure 705. These parameters ensure that the captured images provide the necessary details for tracking.

At a second stage 720, a set of pan, tilt, and zoom values are generated based on one or more of the parameters set during the first stage and which are stored in a predetermined file (e.g. JSON file). This predetermined file serves as an input to a job that captures images while embedding metadata in stage 730, including Farm ID, camera ID, pan, tilt, zoom, and focal length. The captured images, along with this metadata 706, are then processed by a location mapping algorithm 740 that detects the positions of the indicators (caps) and any markers (QR codes) on respective ones of the support structures. Once the indicators are detected, pixel coordinates are determined and stored in the predetermined file 707 ( JSON file). This information is compared across images taken at different time steps in stage 750, to calculate any positional shifts. By using the known feet-to-pixel ratio, a conversion of these pixel-based movements into real-world measurements is performed which indicates how far and in what direction each gantry has moved.

The final output is an updated JSON file 708 containing the revised gantry locations. This process is continuously repeated before capturing images from the customer’s greenhouse, ensuring an up-to-date record of gantry positions over time. Additionally, the system is designed to accept a range of pan, tilt, and zoom values rather than fixed ones, allowing for flexibility in image capture. The reference of the final output being a JSON file is merely exemplary and the output data can be encapsulated or otherwise stored in a different type of data file other than JSON. The file type should not be seen as limiting.

In an embodiment described herein, the tracking algorithm focuses on tracking indicators (yellow caps) on one side of the support structure (gantry), allowing for rapid deployment. This approach enables automated gantry tracking with improved accuracy while maintaining a straightforward and easily implementable solution. The parenthetical reference of the indicators being “yellow caps” and the support structure being a “gantry” is merely exemplary. The indicators as used herein merely need to have a characteristic attribute that is easily identifiable based on pixel values of the respective indicators that are present in an image. Moreover, the support structure may be any structure that is movable in x and y directions and which may support the growth of plants or other vegetation.

Instead of capturing multiple images at each time step, this method captures only a single image per time step, ensuring the indicator remains visible throughout the entire range of motion. This processing includes establishing a reference image by positioning all support structures to a predetermined side of a room (e.g. the leftmost position in the room) and capturing an image with specific Pan, Tilt, and Zoom (PTZ) values. Detection processing is performed on the reference image, and its location information derived from the detection processing is stored for future tracking. Since the indicators are positioned on only one side of the support structure, each image contains a single indicator thereby simplifying processing to be performed by the system responsible for scheduling image capture using the cameras.

In this embodiment, tracking processing is streamlined because a location mapping system receives the captured image, the table’s initial position (when all gantries were positioned to the left), and the stored pixel location of the indicator from the reference image. It then computes and outputs the updated table location.

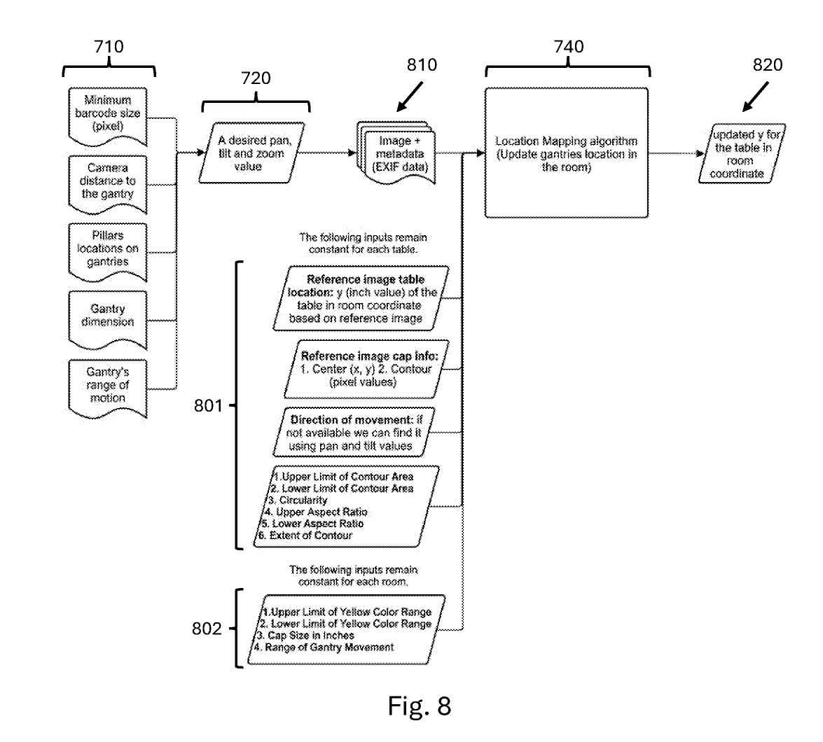

In this embodiment, a modification to the workflow of FIG. 7 is made. This modification includes capturing only one image per time step 810 instead of multiple images. The reference image information, which includes table-specific values, remains constant over time. This results in a simplified and faster implementation, as no additional image capture jobs need to be scheduled by the server (Gateway) that controls an image capturing schedule. FIG. 8 further illustrates that only a single image (for example, of the entire grow environment, or an image from only one imaging device, or the image being of a one or more support structures and/or fixed points in the grow environment) 810 is required for the location mapping algorithm, with all other parameters being table-specific 801 or room-specific 802, eliminating the need for frequent updates. The indicator location and previous support structure position are determined once, based on the reference image and its JSON file information (generated map), making them reusable for all subsequent images to predict the gantry's new location 820 in the room. FIG. 8 illustrates the changes in the workflow. It shows that only the captured image is passed to the location mapping algorithm, while the algorithm also utilizes certain constants derived from the reference image or other predefined values. These constants are specifically determined for indicator detection and tracking purposes, and they remain unchanged over time as they are support structure-specific and room-specific.

It should be noted that the movement of the support structures as descried herein describe movement in only the y direction. As such, information describing the movement of the support structure y direction will be updated in this phase. However, this is merely for exemplary purposes. It should be understood that the same processing can derived if the support structures were configured to move only in the x-direction or, moveable in both the x and y direction. As such, determining distance movement should not be considered limited to y-directional movements.

### System Design

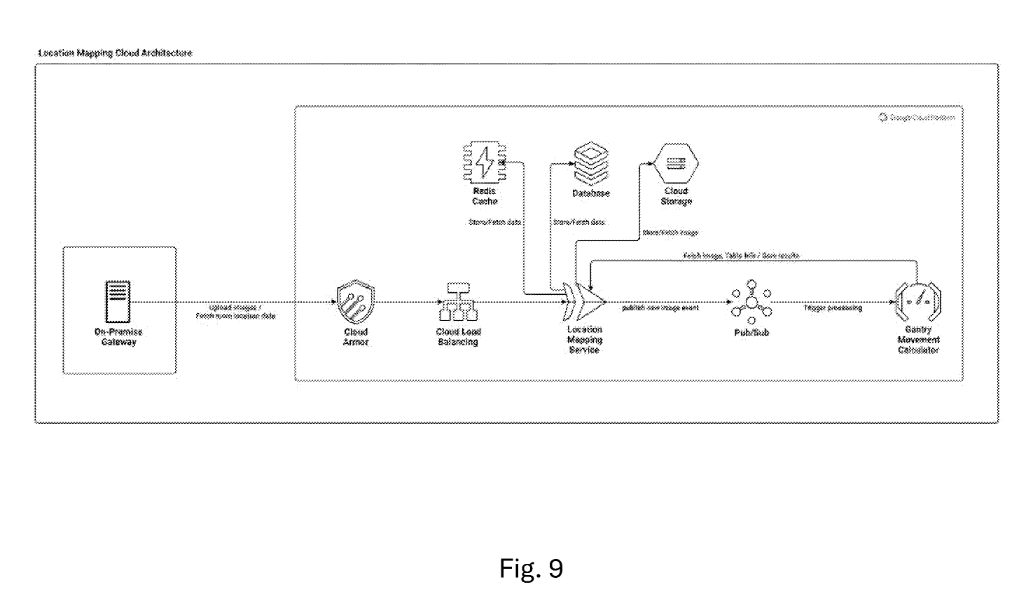

FIG. 9 illustrates the system design according to the present disclosure. The system includes processing to cause images to be captured and received (e.g., uploaded) from an on-premise gateway system (server) to a cloud-based location mapping service. Upon receiving an image, the location mapping service stores it in cloud storage and publishes a Pub/Sub message to notify subscribers of the new upload. The gantry movement tracker system, which is subscribed to this Pub/Sub topic, receives the event, retrieves the image and table details from the location mapping service, and calculates a new Y-coordinate based on the cap's location in the image. The computed Y-coordinate is then sent back to the location mapping service, where it is stored in a database. This updated data is subsequently used to map table names for queries involving specific X and Y coordinates. While the user of a on-premise gateway and a separate cloud system are described, this is merely exemplary and all operations can be performed by a single system, either the gateway or the cloud system.

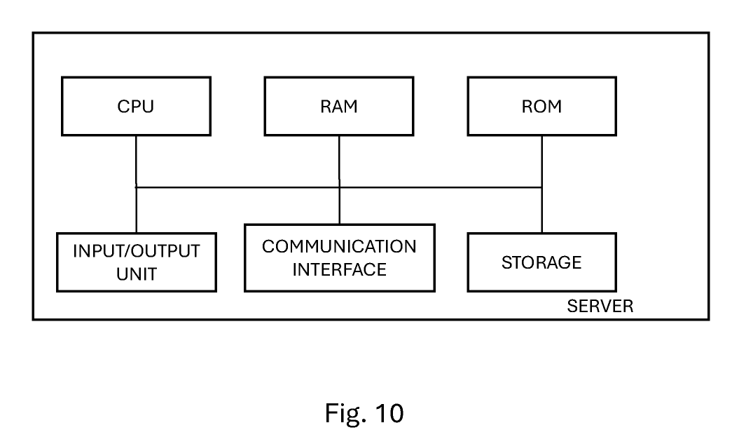

FIG. 10 illustrates the hardware components for executing the tracking algorithm according to the present disclosure. The hardware illustrated in FIG. 2 includes a server having instructions (e.g. computer executable code embodied as a program) stored in memory which when executed perform one more of the control operations described in the present disclosure. In one embodiment, the server (or edge computing device) is local to a location where images that are captured and used for both training and/or classification occur. In another embodiment, the server is a cloud server which is in communication via a communication network with image capture devices and/or other servers with image repositories where images used in the above-described processing techniques are stored.

The server includes one or more CPUs which is configured to control all operations of server by using a set of stored instructions and/or one or more computer programs in conjunction with data stored in the RAM or ROM. The one or more CPUs may include one or more dedicated hardware or a graphics processing unit (GPU), which is different from the CPU, and the GPU or the dedicated hardware may perform a part of the processes by the CPU. As an example of the dedicated hardware, there are an application specific integrated circuit (ASIC), a field-programmable gate array (FPGA), and a digital signal processor (DSP), and the like. The RAM temporarily stores the computer program or data read from the ROM, data supplied from outside via the communication interface and/or data read from the storage, and the like. The ROM stores the computer program and data which do not need to be modified. The ROM includes one or more control programs that control the operations of the server.

The input/output unit includes one or more input components including but not limited to a joystick, a jog dial, a touch panel, a keyboard, a mouse, or the like, and receives user's operation, and inputs various instructions to the CPU. The input/output unit includes output components including a display and or output port to enable connection to an external display device such that a graphical user interface may be displayed thereon. Additionally, the output component may include an audio output device such a speaker. The communication interface communicates with external device such as PC, smartphone, cameras, sensors and the like. The communication with the external devices may be performed by wire using a local area network (LAN) cable, a serial digital interface (SDI) cable, wireless connection or the like, or may be performed wirelessly via an antenna. The communication interface is configured to communicate using standard communication protocols such as WIFI, Bluetooth ® and NFC.

The server also includes storage which may be any one of a hard disk drive, solid-state storage device or the like. It may be internal to the server 20 or alternatively may be a removable storage device. The storage includes a plurality of control programs that are applications which may be executed by the one or more CPUs in order to perform a particular type of operation. The control programs stored in storage include computer executable instructions that are loaded into memory and which configure the one or more CPU’s and/or GPU’s to perform certain operations. Storage also enables program data and other data upon which operations are performed to be stored therein.

Embodiment(s) of the present disclosure, in particular the movement of the imaging device and/or cameras and the operation of the cameras, can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. An I/O interface can be used to provide communication interfaces to input and output devices, which may include a keyboard, a display, a mouse, a touch screen, touchless interface (e.g., a gesture recognition device) a printing device, a light pen, an optical storage device, a scanner, a microphone, a camera, a drive, communication cable and a network (either wired or wireless).

The imaging device (e.g. camera) converts optical signals to electrical signals using a sensor. The conversion may occur in an array of 1 x 1, or greater and may include, for example a photomultiplier tube (PMT), a photodiode, an avalanche photodiode detector (APD), a charge-coupled device (CCD), multi-pixel photon counters (MPPC), Single Photon Avalanche Detector (SPAD), a Complimentary Metal Oxide Semiconductor (CMOS)or other sensor. Also, the function of camera may be implemented by computer executable instructions (e.g., one or more programs) recorded (or stored) on a Storage/RAM of the imaging device and which are executed by a CPU of the imaging device to perform the control described herein.

### Definations

In referring to the description, specific details are set forth in order to provide a thorough understanding of the examples disclosed. In other instances, well-known methods, procedures, components and circuits have not been described in detail as not to unnecessarily lengthen the present disclosure.

It should be understood that if an element or part is referred herein as being "on", "against", "connected to", or "coupled to" another element or part, then it can be directly on, against, connected or coupled to the other element or part, or intervening elements or parts may be present. In contrast, if an element is referred to as being "directly on", "directly connected to", or "directly coupled to" another element or part, then there are no intervening elements or parts present. When used, term "and/or", includes any and all combinations of one or more of the associated listed items, if so provided.

Spatially relative terms, such as “under” “beneath”, "below", "lower", "above", "upper", “proximal”, “distal”, and the like, may be used herein for ease of description to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as "below" or "beneath" other elements or features would then be oriented "above" the other elements or features. Thus, a relative spatial term such as "below" can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable.

The term “about,” as used herein means, for example, within 10%, within 5%, or less. In some embodiments, the term “about” may mean within measurement error.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

The terminology used herein is for the purpose of describing particular embodiments only and is not intended to be limiting. The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “includes”, “including,” and “containing” are to be construed as open-ended terms (i.e., meaning “including, but not limited to,”) unless otherwise noted. Specifically, these terms, when used in the present specification, specify the presence of stated features, integers, steps, operations, elements, and/or components, but do not preclude the presence or addition of one or more other features, integers, steps, operations, elements, components, and/or groups thereof not explicitly stated. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

It will be appreciated that the methods and compositions of the instant disclosure can be incorporated in the form of a variety of embodiments, only a few of which are disclosed herein. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A method for automatically tracking a structure within an environment comprising:
generating a map of a plurality of moveable support structures within a real-space environment;
obtaining a first image of each of the support structures at a first time;
obtaining a second image of each of the support structures at a second time;
determining offset information indicating a change in position of respective ones of the plurality of support structures between the obtained first and second images using a transformation parameter; and
updating the generated map using the determined offset information to update position information for any of the moveable support structures determined to have moved during a time between the first image and the second image.

2. The method according to claim 1, further comprising:
detecting, in the obtained first image, a position of a unique indicator associated with a respective one of the respective moveable support structures;
detecting, in the obtained second image, the position of the unique indicator associated with the respective one of the respective moveable support structures; and
wherein the activity of determining the offset information uses a change in pixel location of the unique indicator between the first obtained image and the second obtained image.

3. The method according to claim 1, further comprising:
obtaining further images of the environment each having position information indicating a position of the environment where the image was obtained;
comparing the position information in the obtained further images with the updated map; and
assigning the obtained further images to a corresponding structure based on the updated map.

4. The method according to claim 1, wherein the support structure is a gantry that supports a grow structure in which plants are being grown.

5. The method according to claim 1, further comprising
determining the transformation parameter by obtaining a pixel-to-feet ratio using a size, in pixels, of an indicator within the obtained first and second images, movement direction and a know size of the indicator in real space.

6. The method according to claim 1, wherein the transformation parameter indicates a displacement distance in real space and direction information; and wherein updating the generated map includes using a displacement distance and direction information to update a position of respective ones of the support structures.

7. The method according to claim 1, further comprising
providing a plurality of image capture devices positioned at predetermined positions within the environment; and the step of obtaining the first image and second images is performed by the plurality of image capture devices.

8. The method according to claim 1, further comprising:
extracting from each of the obtained first and second images, a set of pixels having a predetermined image characteristic; and
using a change in position of the predetermined image characteristic to determine the offset information.

9. The method according to claim 8, wherein the predetermined image characteristic is a grouping of pixels having a same color information.

10. The method according to claim 8, wherein the predetermined image characteristic is a presence of a fluorescent marker and/or presence of white light information.

11. The method according to claim 8, wherein the predetermined image characteristic represents a two-dimensional code.

12. The method according to claim 1, further comprising
providing the obtained first image and obtained second image as input to a trained machine learning model trained to identify one or more indicators on respective support structures;
using output from the trained machine learning model in determining the offset information.

13. The method according to claim 1, wherein the step of obtaining the first image and obtaining the second image further includes obtaining an image of the support structures and a predetermined point in the imaging region, and wherein the step of determining offset information uses a position in the obtained first and second image relative to the predetermined point in the imaging region.

14. The method according to claim 1, wherein after the step of updating the generated map occurs at a first time, the method further obtains subsequent images at a time after the second time and compares a location of the support structure in the subsequent images with the generated map.

15. A server comprising
one or more memories storing instructions; and
one or more processors that, upon execution of the stored instructions, are configured to execute a method comprising:
generating a map of a plurality of moveable support structures within a real-space environment;
obtaining a first image of each of the support structures at a first time;
obtaining a second image of each of the support structures at a second time;
determining offset information indicating a change in position of respective ones of the plurality of support structures between the obtained first and second images using a transformation parameter; and
updating the generated map using the determined offset information to update position information for any of the moveable support structures determined to have moved during a time between the first image and the second image.

16. A system comprising
a plurality of image capture devices configured to obtain images of an environment; and
a server comprising:
one or more memories storing instructions; and
one or more processors that, upon execution of the stored instructions, are
configured to execute a method comprising:
generating a map of a plurality of moveable support structures within a real-space environment;
obtaining a first image of each of the support structures at a first time;
obtaining a second image of each of the support structures at a second time;
determining offset information indicating a change in position of respective ones of the plurality of support structures between the obtained first and second images using a transformation parameter; and
updating the generated map using the determined offset information to update position information for any of the moveable support structures determined to have moved during a time between the first image and the second image.
